(19) United States
(12) Patent Application Publication
(10) Pub. No.: US 2006/0081425 A1
(43) Pub. Date: Apr. 20, 2006

(54) Brake disk and a brakable wheel hub device having the same

(76) Inventor: Hubert Chen, Taichung Hsien (TW)

Correspondence Address: DLA PIPER RUDNICK GRAY CARY US, LLP, 2000 UNIVERSITY AVENUE, E. PALO ALTO, CA, 94303-2248, US

(21) Appl. No.: 10/966,889

(22) Filed: Oct. 15, 2004

(51) Int. Cl. F16D 65/78

(52) U.S. Cl. 188/218 XL

(57) ABSTRACT

A brakable wheel hub device includes a wheel hub shell having a disk securing portion with angularly displaced insert holes or slots extending from an end surface, a brake disk having a disk body and a plurality of keys which are disposed on and which extend axially from the disk body to be inserted into insert holes or slots, respectively, and a locking member having an externally threaded portion which is threadedly engaged with an internally threaded portion or a plurality of internally threaded segments formed in the wheel hub shell so as to force the disk body to displace to the end surface of the wheel hub shell.

### BACKGROUND OF THE INVENTION

1. Field of the Invention

This invention relates to a brake disk and a brakable wheel hub device having the same, more particularly to a brake disk having a plurality of keys that can fit into a hub shell so as to cooperatively form a brakable wheel hub device with the hub shell.

2. Description of the Related Art

In a co-pending U.S. patent application Ser. No. 10/392,992, entitled “Brakable Wheel Hub Device,” filed by the applicant, there is disclosed a bicycle appliance, as shown in FIG. 1, which comprises a wheel hub shell 13, a positioning ring 14, and a locking member 15. The wheel hub shell 13 has a surrounding shell wall 131 rotatably mounted on a wheel axle 11 of a bicycle by means of bearing members 12, and a disk securing portion 132 which extends from the surrounding shell wall 131 radially and outwardly, and which has six axially extending insert holes 133, and an internally threaded portion 134. The positioning ring 14 surrounds the axle 11, and has an abutment wall 141 and six angularly displaced protrusions 142. The protrusions 142 respectively extend through the through holes 21 in a brake disk 20 and are respectively fitted into the insert holes 133. The locking member 15 includes an insert segment 152 which has an externally threaded section to threadedly engage the internally threaded portion 134, and an abutting segment 151 which extends radially from the insert segment 152 and which frictionally abuts against the positioning ring 14, thereby securing the brake disk 20 to the wheel hub shell 13.

In a bicycle construction as such, assembly and disassembly of the brake disk 20 to and from the wheel hub shell 13 can be conducted in a convenient manner. However, as the insert holes 133, the through holes 21 and the protrusions 142 have to be formed with high precision in order to align with one another, manufacture of the positioning ring 14 and the wheel hub shell 13 is complicated.

### SUMMARY OF THE INVENTION

The object of the present invention is to provide a brake disk and a brakable wheel hub device having the same which can overcome the problem associated with the aforesaid co-pending application, and which can be assembled and disassembled with ease.

According to one aspect of this invention, the brake disk includes a disk body and a plurality of keys. The disk body has proximate and distal major surfaces, and inner and outer peripheral edges interconnecting the proximate and distal major surfaces. The keys are angularly displaced from one another about an axis. Each key includes a secured segment secured to the proximate major surface of the brake body and immovable axially relative to the disk body, and a fitted segment opposite to the secured segment and disposed outwardly of the proximate major surface so as to be adapted to fit into a respective one of insert holes formed in a wheel hub shell for mounting the brake disk on the wheel hub shell.

According to another aspect of this invention, the brakable wheel hub device includes a wheel hub shell, a brake disk having a disk body and a plurality of keys, and a locking member. The wheel hub shell has a disk securing portion with an end surface and a plurality of insert holes extending axially from the end surface, and an internally threaded portion surrounding an axis. The locking member includes an externally threaded portion which threadedly engage the internally threaded portion, and an abutting portion which extends radially from the externally threaded portion and which abuts against the distal major surface of the disk body so as to force the disk body to displace to the end surface.

According to a further aspect of this invention, the brakable wheel hub device includes a wheel hub shell, a brake disk, and a locking member. The wheel hub shell includes a disk securing portion with an end surface extending radially, and an inner peripheral wall surrounding an axis and extending from the end surface inwardly and along the axis so as to define a mounting bore. The inner peripheral wall includes a plurality of internally threaded segments and a plurality of recessed segments which are alternately and angularly displaced from one another about the axis. Each recessed segment radially confronts the mounting bore, and is disposed between and cooperates with two adjacent ones of the internally threaded segments to define an insert slot that is communicated with the mounting bore. The brake disk includes a disk body with proximate and distal major surfaces, inner and outer peripheral edges interconnecting the proximate and distal major surfaces, and a plurality of keys which extend from the inner peripheral edge away from the distal major surface and which are angularly displaced from one another about the axis. Each key has inner and outer surfaces radially opposite to each other such that the keys are brought to be inserted into the insert slots from the end surface so as to permit the outer surfaces of the keys to be in frictional contact with the recessed segments. The locking member includes an externally threaded portion which is inserted into the mounting bore and which threadedly engages the internally threaded segments, and an abutting portion which extends radially from the externally threaded portion and which abuts against the distal major surface of the disk body so as to force the disk body to displace to the end surface of the wheel hub shell, thereby bringing the keys to be inserted into the insert slots.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a partly sectional exploded view of a brakable wheel hub device disclosed in co-pending U.S. patent application Ser. No. 10/392,992;

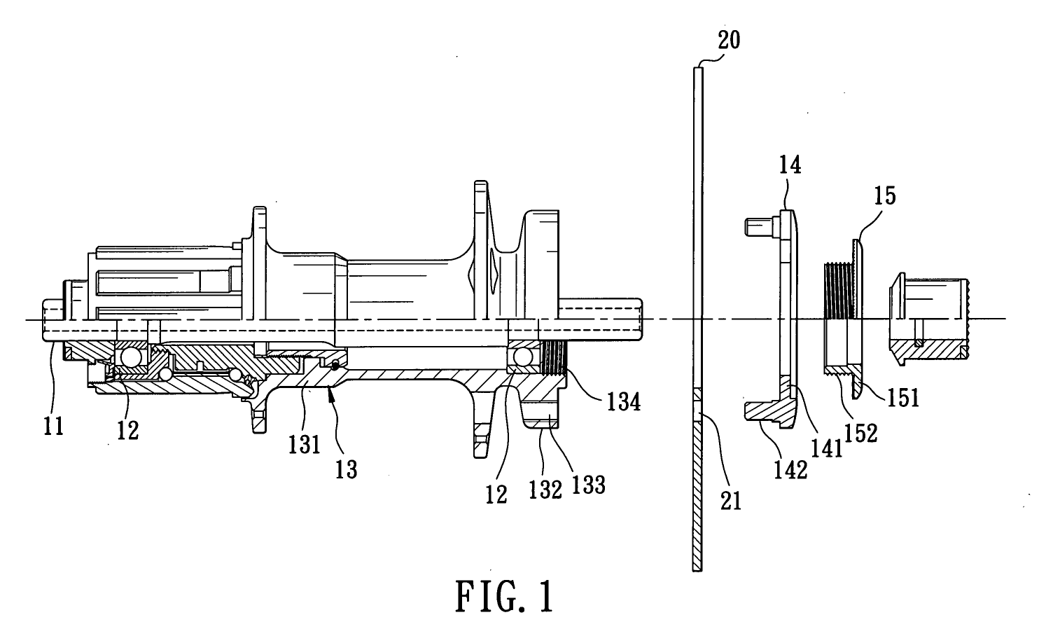

FIG. 2 is a partly sectional exploded view of the first preferred embodiment of a brakable wheel hub device according to this invention;

FIG. 3 is a partly sectional view of the first preferred embodiment in an assembled state;

FIG. 4 is an exploded perspective view of a brake disk of the first preferred embodiment;

FIG. 5 is a partly cutaway perspective view of a wheel hub shell and a brake disk of the second preferred embodiment of a brakable wheel hub device according to this invention;

FIG. 6 is a partly sectional exploded view of the second preferred embodiment;

FIG. 7 is a partly sectional view of the second preferred embodiment in an assembled state; and

FIG. 8 is a cross-sectional view of the brake disk of the second preferred embodiment.

### DETAILED DESCRIPTION OF THE PREFERRED EMBODIMENTS

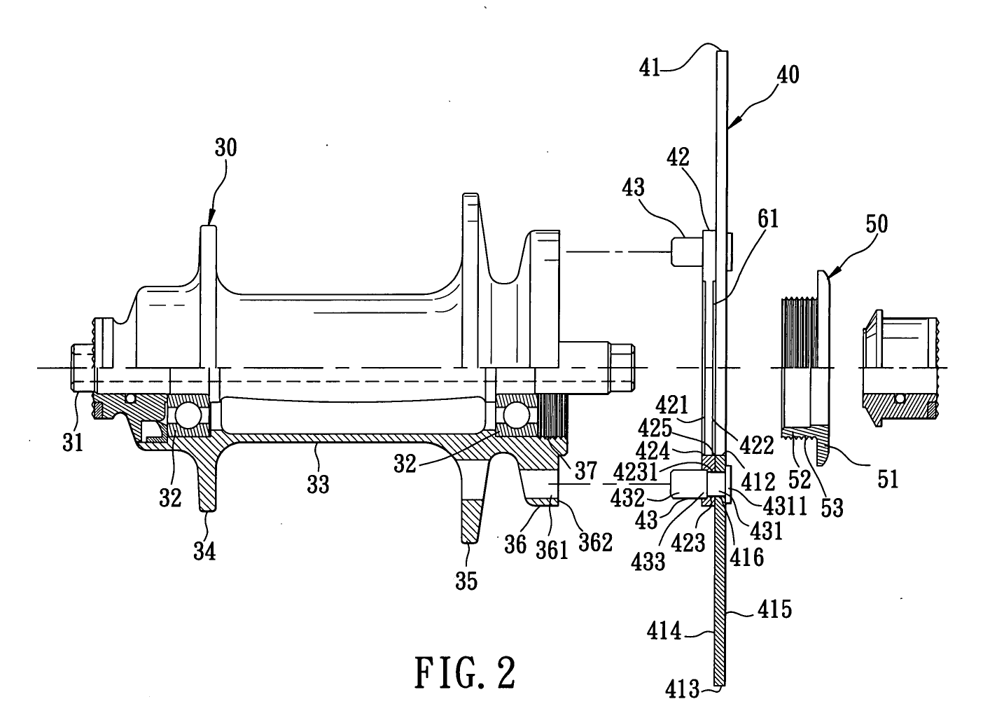

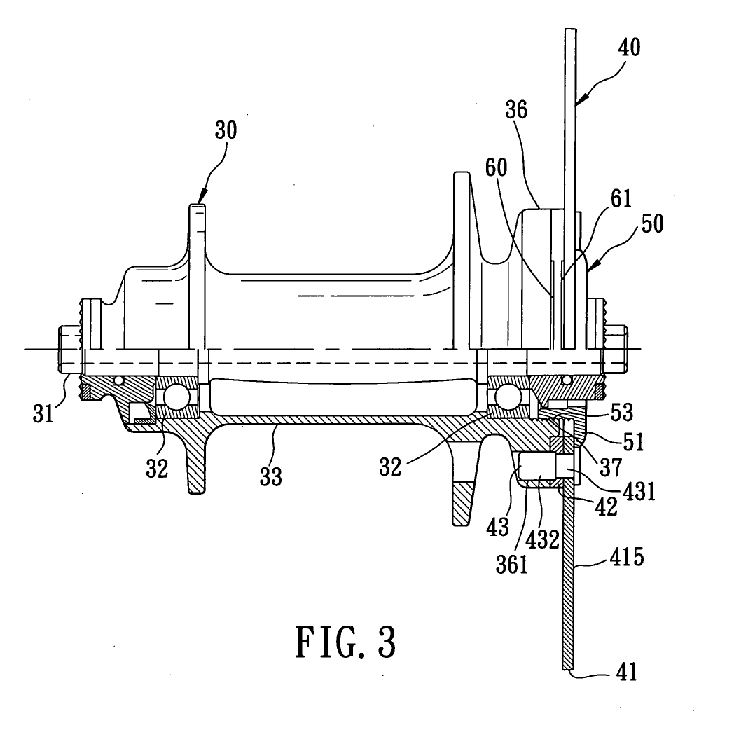

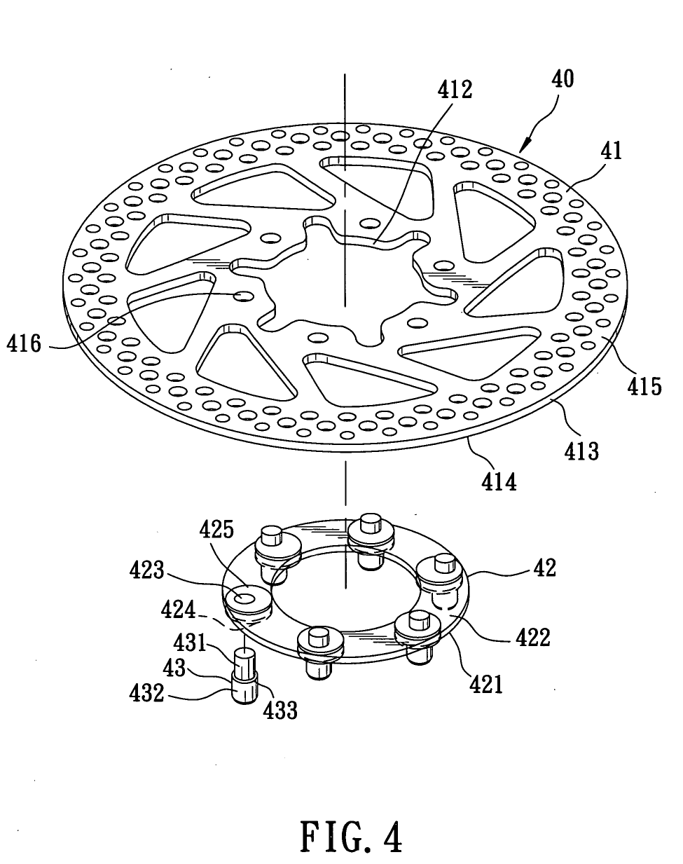

Referring to FIGS. 2 to 4, the first preferred embodiment of a brakable wheel hub device according to the present invention is shown to comprise a wheel hub shell 30, a brake disk 40, and a locking member 50.

The wheel hub shell 30 has a surrounding shell wall 33 mounted on a wheel axle 31 by means of bearing members 32 so as to be rotatable about an axis, two axially opposite spoke mounting flanges 34, 35 extending radially and outwardly from the surrounding shell wall 33, and a disk securing portion 36 disposed laterally of the spoke mounting flange 35. The disk securing portion 36 has an end surface 362 extending in radial directions relative to the axis, and a plurality of insert holes 361 (e.g., six insert holes) extending from the end surface 362 in an axial direction. In this embodiment, the insert holes 361 are equidistantly and angularly displaced from one another. The wheel hub shell 30 further has an internally threaded portion 37 surrounding the axis.

The brake disk 40 includes a disk body 41 and a connecting ring 42. The disk body 41 has a first proximate major surface 414 and a first distal major surface 415 which are opposite to each other in the axial direction and which are respectively proximate to and distal from the end surface 362 of the wheel hub shell 30, inner and outer peripheral edges 412, 413 which are opposite to each other in radial directions relative to the axis and which extend in the axial direction to interconnect the first proximate major surface 414 and the first distal major surface 415, respectively, and a plurality of through holes 416 which extend from the first proximate major surface 414 through the first distal major surface 415, which are angularly displaced from one another about the axis, and which are disposed proximate to the inner peripheral edge 412.

The connecting ring 42 has a second proximate major surface 421 and a second distal major surface 422 which are opposite to each other in the axial direction, and which are respectively proximate to and distal from the end surface 362 of the wheel hub shell 30, and a plurality of securing holes 423 which extend from the second proximate major surface 421 through the second distal major surface 422 in the axial direction and which are angularly displaced from one another about the axis to be registered with the through holes 416, respectively. Specifically, a plurality of inner surrounding steps 4231 are disposed axially and inwardly of the second proximate major surface 421 to border the corresponding securing holes 423. That is, each of the securing holes 423 is formed as a stepped hole. A plurality of keys 43, each including a secured segment 431, a fitted segment 432 opposite to the secured segment 431, and a juncture 433 interconnecting the secured and fitted segments 431, 432, are provided to correspond to the securing holes 423, respectively. The secured segment 431 of each key 43 is made from a malleable material, and has a headless end 4311 distal from the fitted segment 432. The fitted segment 432 of each key 43 has a dimension greater than that of the secured segment 431 so as to form a shoulder at the juncture 433. The secured segment 431 of each key 43 extends from the second proximate major surface 421 through the corresponding securing hole 423 in the connecting ring 42 and the corresponding through hole 416 in the disk body 41 such that the headless end 4311 is disposed outwardly of the first distal major surface 415 of the disk body 41, the shoulder at the juncture 433 abuts against the respective inner surrounding step 4231, and the fitted segment 432 is disposed outwardly of the second proximate major surface 421. The headless end 4311 is beaten to rivet the connecting ring 42 and the disk body 41 together. The fitted segment 432 is brought to fit into the respective insert hole 361 in the axial direction for mounting the brake disk 40 on the wheel hub shell 30. It is noted that the abutment of the shoulders against the steps 4231 helps facilitate the riveting operation.

The connecting ring 42 further has a plurality of disk spacers 425 and a plurality of hub spacers 424. Each of the disk spacers 425 is disposed on and extends from the second distal major surface 422, and surrounds a respective one of the securing holes 423. Each of the hub spacers 424 is disposed on the second proximate major surface 421, and surrounds a respective one of the securing holes 423. Each disk spacer 425 and each hub spacer 424 respectively have a passing hole and an opening which are registered with the corresponding securing hole 423 for passage of the secured segment 431 of the corresponding key 43. The disk spacers 425 abut against the first proximate major surface 414 so as to form a clearance 61 between the second distal major surface 422 and the first proximate major surface 414. The hub spacers 424 abut against the end surface 362 of the disk securing portion 36 when the fitted segments 432 of the keys 43 are fitted into the insert holes 361, thereby forming a space 60 between the end surface 362 and the second proximate major surface 421. Due to the presence of the clearance 61 and the space 60, heat transfer between the disk body 41 and the wheel hub shell 30 during a braking action can be reduced so as to minimize damage to the bearing members 32.

The locking member 50 includes an annular body 52 surrounding the axis and having an externally threaded portion 53 which is disposed to threadedly engage the internally threaded portion 37, and an abutting portion 51 which extends radially from the externally threaded portion 53 and which abuts against the first distal major surface 415 of the disk body 41.

In assembly, the fitted segments 432 of the keys 43 are fitted into the insert holes 361, and the externally threaded portion 53 of the locking member 50 is threadedly engaged with the internally threaded portion 37 of the wheel hub shell 30 to bring the abutting portion 51 to abut against the first distal major surface 415 of the disk body 41 so as to force the disk body 41 to displace to the end surface 362 of the wheel hub shell 30. Thus, assembly and disassembly of the brake disk 40 to and from the wheel hub shell 21 can be conducted in a convenient manner. Moreover, since the keys 43 are configured to rivet the connecting ring 42 and the disk body 41 of the brake disk 40 together and since the fitted segments 432 of the keys 43 are fitted into the insert holes 361, the problem of alignment associated with the wheel hub device in the aforesaid co-pending U.S. patent application Ser. No. 10/392,992 can be obviated. Furthermore, since the keys 43 are coupled to one another by the connecting ring 42, an impact resulting from a shearing force between the keys 43 and the disk body 41 can be reduced.

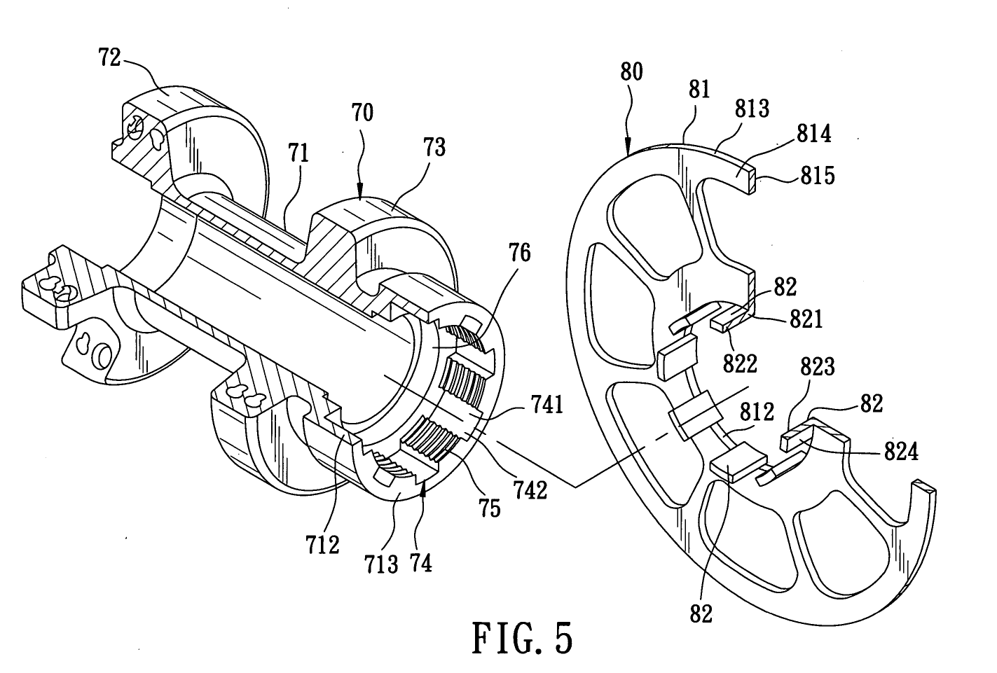

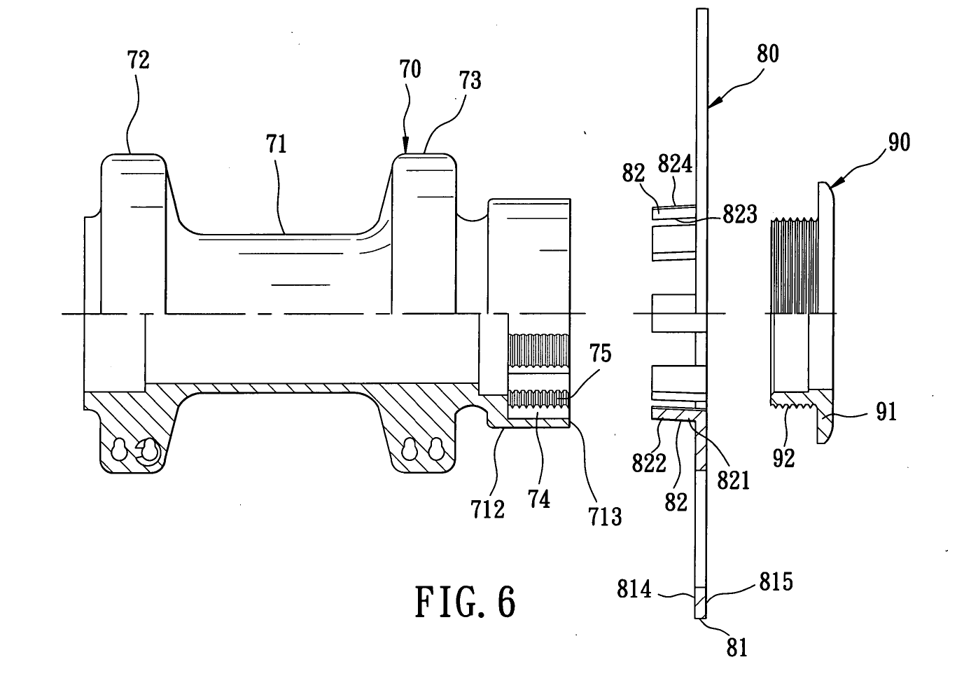

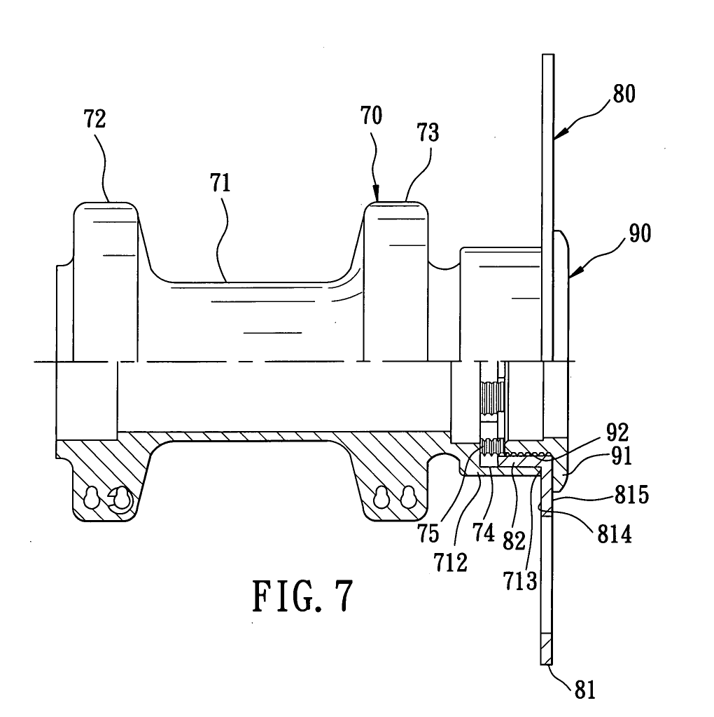

Referring to FIGS. 5 to 8, the second preferred embodiment of a brakable wheel hub device according to this invention is shown to comprise a wheel hub shell 70, a brake disk 80, and a locking member 90.

The wheel hub shell 70 includes a surrounding shell wall 71 mounted on a wheel axle (not shown) to be rotatable about an axis, two axially opposite spoke mounting flanges 72, 73 extending radially and outwardly from the surrounding shell wall 71, and a disk securing portion 712 disposed laterally of the spoke mounting flange 73. The disk securing portion 712 has an end surface 713 extending in radial directions relative to the axis, and an inner peripheral wall 74 surrounding the axis and extending from the end surface 713 inwardly and along the axis so as to define a mounting bore 76. The inner peripheral wall 74 includes a plurality of internally threaded segments 75 which are angularly displaced from one another about the axis, and a plurality of recessed segments 742 which are angularly displaced from one another about the axis. Each recessed segment 742 radially confronts the mounting bore 76, and is disposed between and cooperates with two adjacent ones of the internally threaded segments 75 to define an insert slot 741 that is communicated with the mounting bore 76.

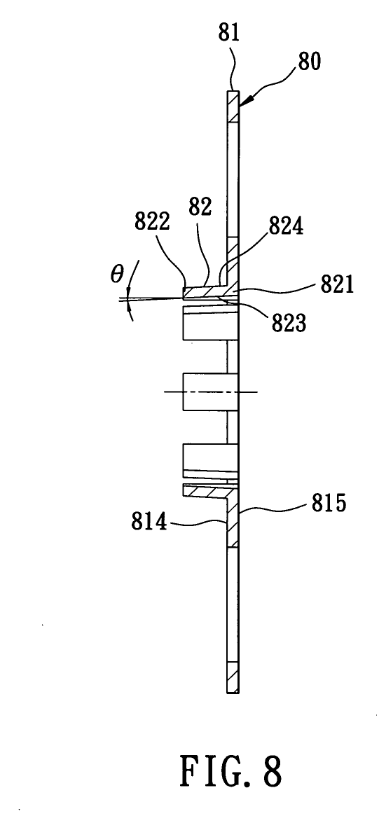

The brake disk 80 includes a disk body 81 which has proximate and distal major surfaces 814, 815 that are opposite to each other in an axial direction, and that are respectively proximate to and distal from the end surface 713 of the disk securing portion 712, inner and outer peripheral edges 812, 813 opposite to each other in radial direction relative to the axis and respectively extending in the axial direction to interconnect the proximate and distal major surfaces 814, 815, and a plurality of keys 82 which extend from the inner peripheral edge 812 in the axial direction away from the distal major surface 815 and which are angularly displaced from one another about the axis. Each key 82 has a connecting end 821 and a bendable end 822 which are respectively disposed proximate to and distal from the inner peripheral edge 812. In addition, each key 82 has inner and outer surfaces 823, 824 radially opposite to each other. The inner surface 823 is inclined radially and inwardly from the connecting end 821 to the bendable end 822 to form an included angle (θ) of 3 degrees with the axis, as shown in FIG. 8. In assembly, the keys 82 are inserted into the respective insert slots 741 from the end surface 713 in the axial direction so as to permit the outer surfaces 824 of the keys 82 to be in frictional contact with the recessed segments 742.

The locking member 90 includes an externally threaded portion 92 which is configured to be inserted into the mounting bore 76 and to threadedly engage the internally threaded segments 75, and an abutting portion 91 which extends radially from the externally threaded portion 92 and which abuts against the distal major surface 815 of the disk body 81 so as to force the disk body 81 to displace to the end surface 713, thereby bringing the keys 82 to be inserted into the insert slots 741. Moreover, when the externally threaded portion 92 is threadedly engaged with the internally threaded segments 75, the bendable ends 822 of the keys 82 are forced to flare radially and outwardly by the screw-in engagement of the externally threaded portion 92 with the internally threaded segments 75 so as to ensure the frictional contact between the keys 82 and the recessed segments 742, thereby reinforcing the connection between the wheel hub shell 70 and the brake disk 80.

As illustrated, during assembly, the keys 82 are inserted into the insert slots 741, and the externally threaded portion 92 is then threadedly engaged with the internally threaded segments 75 to permit the bendable ends 822 of the keys 82 to flare outwardly and to frictionally contact the recessed segments 742. Thus, the assembly and disassembly of the brake disk 80 to and from the wheel hub shell 70 can be conducted with ease. Moreover, since the keys 82 are formed integrally with the disk body 81, the problem of alignment associated with the aforesaid co-pending U.S. patent application Ser. No. 10/392,992 can be obviated.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A brake disk adapted to be secured on a wheel hub shell that is rotatable about an axis, the wheel hub shell including a disk securing portion which has an end surface extending in radial directions relative to the axis, and a plurality of insert holes extending from the end surface in an axial direction, said brake disk comprising:
a disk body having a first proximate major surface and a first distal major surface which are opposite to each other in the axial direction and which are adapted to be respectively proximate to and distal from the end surface of the wheel hub shell, and inner and outer peripheral edges opposite to each other in radial directions relative to the axis and respectively extending in the axial direction to interconnect said first proximate major surface and the first distal major surface; and
a plurality of keys angularly displaced from one another about the axis and proximate to said inner peripheral edge, each of said keys including a secured segment which is secured to said first proximate major surface of said disk body such that each of said keys is immovable relative to said disk body in the axial direction, and a fitted segment which is opposite to said secured segment, and which is disposed outwardly of said first proximate major surface of said disk body so as to be adapted to fit into a respective one of the insert holes in the axial direction for mounting said brake disk on the wheel hub shell.

2. The brake disk of claim 1, wherein said disk body has a plurality of through holes which extend from said first proximate major surface through said first distal major surface and which are angularly displaced from one another about the axis,
said brake disk further comprising a connecting ring having a second proximate major surface and a second distal major surface which are opposite to each other in the axial direction, and which are adapted to be respectively proximate to and distal from the end surface of the wheel hub shell, and a plurality of securing holes which extend from said second proximate major surface through said second distal major surface in the axial direction and which are angularly displaced from one another about the axis to be registered with said through holes, respectively,
each of said keys further including a juncture interconnecting said secured and fitted segments, said secured segment being made from a malleable material, and having a headless end distal from said fitted segment, said secured segment extending from said second proximate major surface through a respective one of said securing holes and a corresponding one of said through holes such that said headless end is disposed outwardly of said first distal major surface of said disk body so as to be beaten to rivet said connecting ring and said disk body together.

3. The brake disk of claim 2, wherein said fitted segment of each of said keys has a dimension greater than that of said secured segment so as to form a shoulder at said juncture, said connecting ring further having a plurality of inner surrounding steps, each of which is disposed axially and inwardly of said second proximate major surface and borders a corresponding one of said securing holes such that said shoulder of each of said keys abuts against a respective one of said inner surrounding steps to facilitate riveting of said connecting ring and said disk body.

4. The brake disk of claim 2, wherein said connecting ring further has a plurality of disk spacers which are disposed on and which extend from said second distal major surface, and which surround said securing holes, respectively, each of said disk spacers having a passing hole registered with a corresponding one of said securing holes for passage of said secured segment, said disk spacers abutting against said first proximate major surface so as to form a clearance between said second distal major surface and said first proximate major surface for reducing heat transfer between said disk body and the wheel hub shell during a braking action.

5. The brake disk of claim 4, wherein said connecting ring further has a plurality of hub spacers which are disposed on and which extend from said second proximate major surface, and which surround said securing holes, respectively, each of said hub spacers having an opening registered with a corresponding one of said securing holes for passage of said secured segment, said hub spacers being adapted to abut against the end surface of the disk securing portion when said fitted segments are fitted into the insert holes so as to form a space between the end surface and said second proximate major surface for reducing heat transfer therebetween.

6. A brakable wheel hub device rotatable about an axis, comprising:
a wheel hub shell including a disk securing portion which has an end surface extending in radial directions relative to the axis, and a plurality of insert holes extending from said end surface in an axial direction;
a disk body having a first proximate major surface and a first distal major surface which are opposite to each other in the axial direction and which are respectively proximate to and distal from said end surface of said wheel hub shell, and inner and outer peripheral edges opposite to each other in radial directions relative to the axis and respectively extending in the axial direction to interconnect said first proximate major surface and said first distal major surface; and
a plurality of keys angularly displaced from one another about the axis and disposed proximate to said inner peripheral edge, each of said keys including a secured segment which is secured to said first proximate major surface of said disk body such that each of said keys is immovable relative to said disk body in the axial direction, and a fitted segment which is opposite to each other, and which is disposed outwardly of said first proximate major surface of said disk body so as to fit into a respective one of said insert holes in the axial direction for mounting said brake disk on said wheel hub shell.

7. The brakable wheel hub device of claim 6, wherein said disk body has a plurality of through holes which extend from said first proximate major surface through said first distal major surface and which are angularly displaced from one another about the axis,
said brakable wheel hub device further comprising a connecting ring having a second proximate major surface and a second distal major surface which are opposite to each other in the axial direction, and which are respectively proximate to and distal from said end surface of said wheel hub shell, and a plurality of securing holes which extend from said second proximate major surface through said second distal major surface in the axial direction and which are angularly displaced from one another about the axis to be registered with said through holes, respectively,
each of said keys further including a juncture interconnecting said secured and fitted segments, said secured segment being made from a malleable material, and having a headless end distal from said fitted segment, said secured segment extending from said second proximate major surface through a respective one of said securing holes and a corresponding one of said through holes such that said headless end is disposed outwardly of said first distal major surface of said disk body so as to be beaten to rivet said connecting ring and said disk body together.

8. The brakable wheel hub device of claim 7, wherein said wheel hub shell has an internally threaded portion which surrounds the axis, said device further comprising a locking member including an externally threaded portion which is disposed to threadedly engage said internally threaded portion, and an abutting portion which extends radially from said externally threaded portion and which abuts against said first distal major surface of said disk body so as to force said disk body to displace to said end surface of said wheel hub shell.

9. The brakable wheel hub device of claim 7, wherein said connecting ring further has a plurality of disk spacers which are disposed on and which extend from said second distal major surface, and which surround said securing holes, respectively, each of said disk spacers having a passing hole registered with a corresponding one of said securing holes for passage of said secured segment, said disk spacers abutting against said first proximate major surface so as to form a clearance between said second distal major surface and said first proximate major surface for reducing heat transfer between said disk body and said wheel hub shell during a braking action.

10. The brakable wheel hub device of claim 9, wherein said connecting ring further has a plurality of hub spacers which are disposed on and which extend from said second proximate major surface, and which surround said securing holes, respectively, each of said hub spacers having an opening registered with a corresponding one of said securing holes for passage of said secured segment, said hub spacers abutting against said end surface of said disk securing portion when said fitted segments are fitted into said insert holes so as to form a space between said end surface and said second proximate major surface for reducing heat transfer therebetween.

11. A brakable wheel hub device rotatable about an axis, comprising:
a wheel hub shell including a disk securing portion which has an end surface extending in radial directions relative to the axis, and an inner peripheral wall surrounding the axis and extending from said end surface inwardly and along the axis so as to define amounting bore, said inner peripheral wall including a plurality of internally threaded segments which are angularly displaced from one another about the axis, and a plurality of recessed segments which are angularly displaced from one another about the axis, each of said recessed segments radially confronting said mounting bore, and being disposed between and cooperating with two adjacent ones of said internally threaded segments to define an insert slot that is communicated with said mounting bore;
a brake disk including a disk body which has proximate and distal major surfaces that are opposite to each other in an axial direction, and that are respectively proximate to and distal from said end surface of said disk securing portion, inner and outer peripheral edges opposite to each other in radial directions relative to the axis and respectively extending in the axial direction to interconnect said proximate and distal major surfaces, and a plurality of keys which extend from said inner peripheral edge in the axial direction away from said distal major surface and which are angularly displaced from one another about the axis, each of said keys having inner and outer surfaces radially opposite to each other, and being configured such that said keys are brought to be inserted into said insert slots from said end surface in the axial direction so as to permit said outer surfaces of said keys to be in frictional contact with said recessed segments; and
a locking member including an externally threaded portion which is configured to be inserted into said mounting bore and to threadedly engage said internally threaded segments, and an abutting portion which extends radially from said externally threaded portion and which abuts against said distal major surface of said disk body so as to force said disk body to displace to said end surface of said wheel hub shell, thereby bringing said keys to be inserted into said insert slots.

12. The brakable wheel hub device of claim 11, wherein each of said keys has a connecting end and a bendable end which are respectively disposed proximate to and distal from said inner peripheral edge, said inner surface of each of said keys being inclined radially and inwardly from said connecting end to said bendable end such that when said externally threaded portion is threadedly engaged with said internally threaded segments, said bendable ends of said keys are forced to flare radially and outwardly by screw-in engagement of said externally threaded portion with said internally threaded segments so as to ensure the frictional contact between said keys and said recessed segments.

13. The brakable wheel hub device of claim 12, wherein said inner surface of each of said keys forms an included angle of 3 degrees with the axis.
